(19) United States
(12) Patent Application Publication
(10) Pub. No.: US 2014/0061527 A1
(43) Pub. Date: Mar. 6, 2014

(54) VALVE BODY WITH IMPROVED LOWER FLOW CAVITY

(71) Applicants: Jeremy R. Hilsabeck, Marshalltown, IA (US); Lonnie O. Davies, JR., Newton, IA (US); Chad M. Engle, Marshalltown, IA (US); Anders J. Skaar, Eagan, MN (US); Daniel H. Forsman, Rochester, MN (US)

(72) Inventors: Jeremy R. Hilsabeck, Marshalltown, IA (US); Lonnie O. Davies, JR., Newton, IA (US); Chad M. Engle, Marshalltown, IA (US); Anders J. Skaar, Eagan, MN (US); Daniel H. Forsman, Rochester, MN (US)

(21) Appl. No.: 13/598,950

(22) Filed: Aug. 30, 2012

(51) Int. Cl. F16K 27/00

(52) U.S. Cl. 251/356

(57) ABSTRACT

A valve body includes first and second openings, a gallery, and first and second flow conduit portions. The openings are centered on a central axis of the valve body. The gallery is disposed between the openings and includes a cylindrical space on a gallery axis that is perpendicular to the central axis. The first flow conduit portion extends between the first opening and a side opening of the gallery. The second flow conduit portion extends between the second opening and a bottom opening of the gallery. The second flow conduit portion includes a straight cylindrical conduit section in communication with and extending away from the bottom opening of the gallery. The straight cylindrical conduit section has a diameter that is equal to or less than a diameter of the bottom opening of the gallery to facilitate fluid flow through the valve body.

### FIELD OF THE DISCLOSURE

The present disclosure is directed to a valve body and, more particularly, a globe style valve body.

### BACKGROUND

Globe style valve bodies typically have tortuous flow paths that result in many fluid inefficiencies. Moreover, globe style valve bodies tend to include a flow path that changes from having a circular cross-section at the inlet/outlet openings to having an elliptical cross-section at a location below the valve port. The elliptical portion of the flow path is generally much larger in dimension than the valve port diameter, which leads to an abrupt restriction in the flow path further reducing efficiency. This change in shape also introduced turbulence in the fluid flow, which can generate and/or increase, noise and vibrations. The negative effects on flow efficiency become exaggerated even further when the overall flange-to-flange length of any given globe style valve body is shortened because, ultimately, the flow path becomes compressed and more tortuous.

### SUMMARY

One aspect of the present disclosure provides a valve body including a first opening, a second opening, a gallery, a first flow conduit portion and a second flow conduit portion. The first and second openings are centered on a central axis of the valve body. The gallery is disposed between the first and second openings for accommodating a trim assembly, and includes a cylindrical space positioned on a gallery axis that is perpendicular to the central axis. The first flow conduit portion extends between the first opening and a side opening of the gallery. The second flow conduit portion extends between the second opening and a bottom opening of the gallery. Moreover, the second flow conduit portion includes a lower cavity sub-portion disposed immediately below the bottom opening and a side cavity sub-portion disposed between the lower cavity sub-portion and the second opening. The lower cavity sub-portion includes an elbow conduit section and a straight cylindrical conduit section disposed between the elbow conduit section and the bottom opening of the gallery. The straight cylindrical conduit section extends away from the bottom opening of the gallery and has a conduit diameter that is equal to or less than a gallery diameter of the bottom opening of the gallery. The elbow conduit section extends away from the straight cylindrical conduit section along a curved axis to the side cavity sub-portion.

Another aspect of the disclosure provides a valve body including a first opening, a second opening, a gallery, a first flow conduit portion, a second flow conduit portion, a first flow axis, and a second flow axis. The first and second openings are centered on a central axis of the valve body. The gallery is disposed between the first and second openings for accommodating a trim assembly, and includes a cylindrical space positioned on a gallery axis that is perpendicular to the central axis. The first flow conduit portion extends between the first opening and a side opening of the gallery. The second flow conduit portion extends between the second opening and a bottom opening of the gallery. The first flow axis extends along a center of the first flow conduit portion between the first opening and the side opening of the gallery. The second flow axis extends along a center of the second flow conduit portion between the second opening and the bottom opening of the gallery. At least a portion of the second flow axis is aligned with the gallery axis at a location immediately adjacent the bottom opening of the gallery.

### BRIEF DESCRIPTION OF THE DRAWINGS

FIG. 1 is a cross-sectional side view of a globe style valve body constructed in accordance with the principles of the present disclosure.

FIG. 2 is a cross-section through line 2-2 of FIG. 1, as through FIG. 1 were a complete valve body, and showing an alternative version.

### DETAILED DESCRIPTION

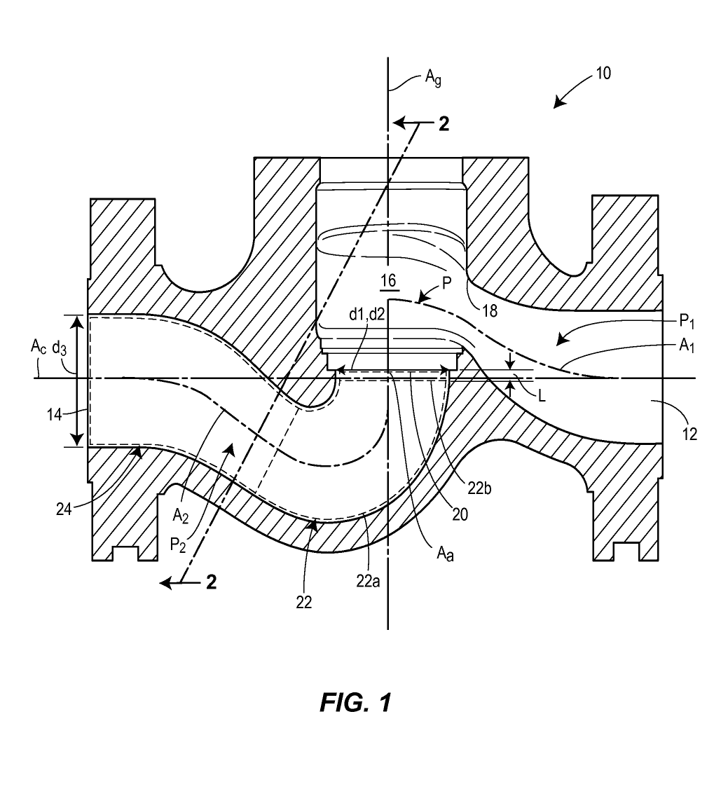

FIG. 1 depicts a cross-sectional side view of a globe style valve body 10 constructed in accordance with the principles of the present disclosure. The valve body 10 includes a first opening 12, a second opening 14, and a gallery 16 disposed between the first and second openings 12, 14. Each opening 12, 14 includes a circular opening centered on a central axis Ac of the valve body 10, which is horizontal. In the depicted version, the first and second openings 12, 14 are flanged openings for connecting in a pipeline, but other versions may offer openings adapted for weld ends or openings adapted for other types of connections. The gallery 16 is adapted to accommodate a trim assembly (not shown) such as a seat ring, a cage, etc. and a movable control element (not shown), in a known manner. The gallery 16 includes a generally cylindrical space positioned on a gallery axis Ag that is vertical and therefore perpendicular to the central axis Ac of the valve body 10.

The valve body 10 includes a first flow conduit portion P1 and a second flow conduit portion P2 defining a flow path P through the valve body 10. As depicted, the first flow conduit portion P1 includes a first flow axis A1 extending along a center thereof between the first opening 12 and a side opening 18 of the gallery 16. The second flow conduit portion P2 includes a second flow axis A2 extending along a center thereof between the second opening 14 and a bottom opening 20 of the gallery 16.

As indicated with dashed lines in FIG. 1, the second flow conduit portion P2 can be described as including a lower cavity sub-portion 22 disposed immediately below the bottom opening 20 of the gallery 16 and a side cavity sub-portion 24 disposed between the lower cavity sub-portion 22 and the second opening 14. Furthermore, as also indicated with dashed lines, the lower cavity sub-portion 22 can be described as including an elbow conduit section 22a and a straight cylindrical conduit section 22b. The straight cylindrical conduit section 22b is disposed between the elbow conduit section 22a and the bottom opening 20 of the gallery 16 and is in fluid communication with and extends away from the bottom opening 20 of the gallery 16 along the gallery axis Ag. That is, the straight cylindrical conduit section 22b includes a central axis Aa that is aligned with the gallery axis Ag. The elbow conduit section 22a extends away from the straight cylindrical conduit section 22b along a curved portion of the second flow axis A2 toward the side cavity sub-portion 24 of the second flow conduit portion P2.

In the disclosed version of the valve body 10, the straight cylindrical conduit section 22b can include a diameter d1 and a longitudinal central dimension L. The diameter d1 of the straight cylindrical conduit section 22b can be constant and equal to or less than a diameter d2 of the bottom opening 20 of the gallery 16. Additionally, the diameter d1 of the straight cylindrical conduit section 22b can be equal to or less than a diameter d3 of the second opening 14. Moreover, in the depicted version of the valve body 10, the longitudinal dimension L of the straight cylindrical conduit section 22b is less than its diameter d1 or, said another way, the diameter d1 of the straight cylindrical conduit section 22b is greater than its longitudinal dimension L. Other versions of course can be dimensioned differently.

In one version, the diameters d1, d2 of the straight cylindrical conduit section 22b and the bottom opening 20 of the gallery 16 can be approximately 6″ (152.4 millimeters) and the diameter d3 of the second opening 14 can be approximately 7.5″ (190 millimeters). This reduction in diameter can occur in the second flow conduit portion P2 generally gradually from the second opening 14 to the straight cylindrical conduit section 22b.

As mentioned, the first and second openings 12, 14 of the disclosed valve body 10 are circular openings and the straight cylindrical conduit section 22b is also circular in cross-section. In one version, the second flow conduit portion P2 includes a circular cross-section along its entire length, extending between the second opening 14 and the bottom opening 20 of the gallery 16. In another version of the disclosed valve body 10, a portion of the elbow conduit section 22a of the second flow conduit portion P2 can have an oval cross-section. The term “oval,” as used herein, means any non-circular shape that may be used including, for example, an egg shape, an ellipse, a racetrack shape, etc.

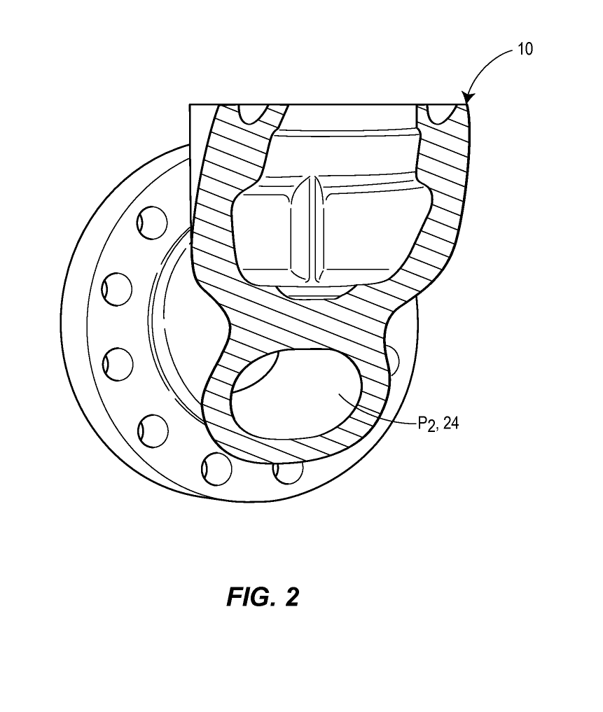

In one version of the valve body 10, the second flow conduit portion P2 can include an oval cross-section in a region corresponding to where line 2-2 passes through the valve body 10 in FIG. 1. As shown in FIG. 2, the cross-section of the second flow conduit portion P2 in the region of line 2-2 in this alternative version can be only slightly oval, as might be required to satisfy certain manufacturing constraints, for example, without sacrificing fluid flow efficiency. While the cross-section through line 2-2 can include this slight oval, its cross-sectional area would remain generally constant relative to its immediately adjoining circular cross-sectional regions of the second flow conduit portion P2. Even in such a version where the second flow conduit portion P2 includes the above-described oval cross-sectional region, the remainder of the lower cavity sub-portion 22 and side cavity sub-portion 24 of the second flow conduit portion P2 include circular cross-sections throughout.

Depending on the desired operational configuration, the valve body 10 of the present disclosure can be arranged in a flow-up configuration such that the second opening 14 is the inlet of the valve body 10 and the first opening 12 is the outlet, or it can be arranged in a flow-down configuration such that the first opening 12 is the inlet and the second opening 14 is the outlet.

Based on the foregoing construction, the arrangement of the first flow conduit portion P1, second flow conduit portion P2, and gallery 16 cooperate to streamline and increase the efficiency of the fluid flow through the valve 10. For example, in a flow-up configuration, fluid flows into the valve body 10 at the second opening 14 and through the second flow conduit portion P2 along the second flow axis A2. As the fluid flows through the lower cavity sub-portion 22, it first flows through the elbow conduit section 22a and then through the straight cylindrical conduit section 22b, before arriving at the bottom opening 20 of the gallery 16.

Because the straight cylindrical conduit section 22b is straight and includes a constant diameter d1 that is equal to or less than a diameter d2 of the bottom opening 20, the fluid flows freely from the second flow conduit portion P2 into the gallery 16. Said another way, no aspect of the valve body 10 interferes with the fluid flowing between the second flow conduit portion P2 and the gallery 16. This free flow of fluid is further assisted by the fact that the second flow axis A2 is aligned with the gallery axis Ag throughout the straight cylindrical conduit section 22b. Said another way, and as mentioned above, the straight cylindrical conduit section 22b and the gallery 16 are co-axially aligned (i.e., they extend along and are centered on a common linear axis). Further still, another aspect of the disclosure that assists with the free flow of fluid through the valve body 10 is the fact that the entire elbow conduit section 22a of the lower cavity sub-portion 22 is circular in cross-section, which enables the fluid flowing therethrough to take a natural curving flow path into or out of the gallery 16.

From the foregoing, it can be seen that the present disclosure advantageously provides an improved valve body that effectively reduces and/or eliminates turbulence along the flow path at various locations, including at least a location below the gallery. This reduction and/or elimination of turbulence advantageously can reduce and/or eliminate noise and vibrations caused by such turbulent fluid flow.

While the foregoing disclosure provides various versions of a valve body of the present invention, the disclosure is not limited to the specifics disclosed. Rather, the disclosure is merely exemplary in nature. The invention is to be determined and defined by the spirit and scope of the following claims and all equivalents thereof.

1. A valve body comprising:
a first opening centered on a central axis of the valve body;
a second opening centered on the central axis;
a gallery disposed between the first and second openings for accommodating a trim assembly, the gallery comprising a cylindrical space positioned on a gallery axis that is perpendicular to the central axis;
a first flow conduit portion extending between the first opening and a side opening of the gallery; and
a second flow conduit portion extending between the second opening and a bottom opening of the gallery, the second flow conduit portion including a lower cavity sub-portion disposed immediately below the bottom opening and a side cavity sub-portion disposed between the lower cavity sub-portion and the second opening,
the lower cavity sub-portion including an elbow conduit section and a straight cylindrical conduit section disposed between the elbow conduit section and the bottom opening of the gallery, the straight cylindrical conduit section extending away from the bottom opening of the gallery and having a conduit diameter that is equal to or less than a gallery diameter of the bottom opening of the gallery, the elbow conduit section extending away from the straight cylindrical conduit section along a curved axis to the side cavity sub-portion, wherein a portion of the elbow conduit section adjacent to the straight cylindrical conduit section has a length that is equal to a longitudinal dimension of the straight cylindrical conduit section and has a constant circular cross-sectional shape having a diameter that is equal to the conduit diameter of the straight cylindrical conduit section.

2. The valve body of claim 1, wherein the straight cylindrical conduit section of the lower cavity sub-portion is centered on the gallery axis.

3. The valve body of claim 1, wherein at least portions of the side cavity sub-portion and the lower cavity sub-portion of the second flow conduit portion have a circular cross-section.

4. The valve body of claim 1, wherein the second flow conduit portion includes a circular cross-section along its entire length.

5. The valve body of claim 1, wherein a diameter of the cross-section of the second flow conduit portion gradually decreases from the second opening to a location adjacent to the bottom opening of the gallery.

6. The valve body of claim 1, wherein a portion of the elbow conduit section of the second flow conduit portion has an oval cross-section.

7. The valve body of claim 1, wherein the side cavity sub-portion has a side cavity diameter that is greater than the conduit diameter of the straight cylindrical conduit section.

8. The valve body of claim 1, wherein the first opening is an inlet of the valve body and the second opening is an outlet of the valve body.

9. The valve body of claim 1, wherein the second opening is an inlet of the valve body and the first opening is an outlet of the valve body.

10. The valve body of claim 1, wherein the longitudinal dimension of the straight cylindrical conduit section is less than the conduit diameter.

11. A valve body, comprising:
a first opening centered on a central axis of the valve body;
a second opening centered on the central axis;
a gallery disposed between the first and second openings for accommodating a trim assembly, the gallery comprising a cylindrical space positioned on a gallery axis that is perpendicular to the central axis;
a first flow conduit portion extending between the first opening and a side opening of the gallery;
a second flow conduit portion extending between the second opening and a bottom opening of the gallery;
a first flow axis extending along a center of the first flow conduit portion between the first opening and the side opening of the gallery; and
a second flow axis extending along a center of the second flow conduit portion between the second opening and the bottom opening of the gallery, at least a portion of the second flow axis being aligned with the gallery axis at a location immediately adjacent the bottom opening of the gallery,
wherein the second flow conduit portion includes a lower cavity sub-portion disposed immediately below the bottom opening of the gallery and a side cavity sub-portion disposed between the lower cavity sub-portion and the second opening,
wherein the lower cavity sub-portion includes a straight cylindrical conduit section disposed adjacent to the bottom opening of the gallery and centered along the second flow axis and the gallery axis,
wherein the lower cavity sub-portion of the second flow conduit portion further comprises an elbow conduit section disposed between the straight cylindrical conduit section and the second opening, and
wherein a portion of the elbow conduit section adjacent to the straight cylindrical conduit section has a length that is equal to a longitudinal dimension of the straight cylindrical conduit section and has a constant circular cross-sectional shape having a diameter that is equal to a conduit diameter of the straight cylindrical conduit section.

12. (canceled)

13. The valve body of claim 11, wherein the conduit diameter is equal to or less than a gallery diameter of the bottom opening of the gallery.

14. The valve body of claim 11, wherein at least portions of the side cavity sub-portion and the lower cavity sub-portion of the second flow conduit portion have a circular cross-section.

15. The valve body of claim 11, wherein the second flow conduit portion includes a circular cross-section along its entire length.

16. The valve body of claim 11, wherein a diameter of the cross-section of the second flow conduit portion gradually decreases from the second opening to a location adjacent to the bottom opening of the gallery.

17. The valve body of claim 11, wherein a portion of the elbow conduit section has an oval cross-section.

18. The valve body of claim 11, wherein the side cavity sub-portion has a side cavity diameter that is larger than the conduit diameter of the straight cylindrical conduit section.

19. The valve body of claim 11, wherein the first opening is an inlet of the valve body and the second opening is an outlet of the valve body.

20. The valve body of claim 11, wherein the second opening is an inlet of the valve body and the first opening is an outlet of the valve body.

21. The valve body of claim 11, wherein the straight cylindrical conduit section includes a longitudinal dimension that is less than the conduit diameter.
